(19) United States
(12) Patent Application Publication
(10) Pub. No.: US 2011/0273492 A1
(43) Pub. Date: Nov. 10, 2011

(54) DISPLAY APPARATUS AND DISPLAY PANEL DRIVING METHOD

(75) Inventors: Takashi Date, Machida-shi (JP); Hiroshi Saito, Atsugi-shi (JP)

(73) Assignee: CANON KABUSHIKI KAISHA, Tokyo (JP)

(21) Appl. No.: 13/095,694

(22) Filed: Apr. 27, 2011

(30) Foreign Application Priority Data
May 10, 2010 (JP) 2010-108787

(51) Int. Cl. G09G 5/10; G06F 3/038

(52) U.S. Cl. 345/691; 345/204; 345/690

(57) ABSTRACT

An apparatus includes a display panel, a scanning circuit, a modulation circuit and a potential generation circuit. The display panel includes a matrix wiring including a plurality of row wirings and column wirings, an electron source connected to the matrix wiring, a display member opposed to the electron source, an anode provided on the display member in an overlapping manner, and a feeding member connected to the anode in a joint portion, a scanning circuit, connected to the plurality of row wirings, a modulation circuit configured to output a modulated potential to the plurality of column wirings, and a potential generation circuit configured to output a first potential, which is higher than a potential of the electron source, to the feeding member during the first selected time period and a second potential, which is higher than the first potential, to the feeding member during the second selected time period.

### BACKGROUND OF THE INVENTION

1. Field of the Invention

The present invention relates to a display apparatus. In particular, the present invention relates to a method for controlling an anode potential in a field emission display.

2. Description of the Related Art

A display panel of a field emission display (FED) includes an electron source, an anode, and a light emitting layer. The anode and the light emitting layer are opposed to the electron source. The display panel displays an image by excitation-illuminating a light emitting layer by energy of the electron, which is given to the electron by accelerating an electron emitted from the electron source by a potential difference (anode voltage) between an anode potential given to an anode and a potential of the electron source.

In an FED, the area of an anode is substantially as large as the area of a display surface. Accordingly, the potential distribution generated on the anode (distribution of the anode potential) becomes more intense as a display surface becomes larger.

Japanese Patent Application Laid-Open No. 2001-332200 discusses that the voltage of a metal back (anode) may become lower as the distance between a feeding point from an accelerating voltage source and the metal back becomes larger.

Japanese Patent Application Laid-Open No. 2004-246250 discusses an image display apparatus which includes, to reduce the degree of dependence of effective number of bits on luminance, a voltage supply unit that applies an anode voltage and a voltage adjustment unit that adjusts the anode voltage. However, even in the image display apparatus discussed in Japanese Patent Application Laid-Open No. 2004-246250, which includes the voltage adjustment unit capable of adjusting the anode potential, effective anode potentials at a display position may be distributed due to voltage drop, which may occur depending on the distance between the feeding point for anode and an electron injection position on the anode (i.e., the display position).

The above-described dependence of an effective anode potential on the display position may cause display unevenness on a display surface of a display panel.

### SUMMARY OF THE INVENTION

According to an aspect of the present invention, a display apparatus includes a display panel, which includes a matrix wiring having a plurality of row wirings and a plurality of column wirings, an electron source having a plurality of electron emitting devices connected to the matrix wiring, a display member opposed to the electron source, an anode provided on the display member in an overlapping manner, and a feeding member connected to the anode via a joint portion, a scanning circuit connected to the plurality of row wirings, a modulation circuit configured to output a modulated potential to the plurality of column wirings, and a potential generation circuit configured to output a first potential, which is higher than a potential of the electron source, to the feeding member during the first selected time period and a second potential, which is higher than the first potential, to the feeding member during the second selected time period. In the display apparatus, the plurality of row wirings includes a first row wiring and a second row wiring located farther from the joint portion than the first row wiring. The scanning circuit is configured to output, in a first selected time period within one scanning time period, a selection potential to the first row wiring, and a non-selection potential to the second row wiring, and in a second selected time period within the one scanning time period, the non-selection potential to the first row wiring, and the selection potential to the second row wiring.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 is a schematic diagram illustrating an exemplary example of a display apparatus.

FIGS. 2A through 2D are schematic diagrams illustrating an exemplary example of a display panel.

FIG. 3 is a schematic diagram illustrating an exemplary example of a display apparatus.

FIGS. 4A and 4B are schematic diagrams illustrating a characteristic of the present invention.

FIGS. 5A through 5C are schematic diagrams illustrating an exemplary example of a display panel.

FIG. 6 is a schematic diagram illustrating a first exemplary example of the present invention.

FIG. 7 is a schematic diagram illustrating a second example exemplary of the present invention.

FIG. 8 is a schematic diagram illustrating a third exemplary example of the present invention.

### DESCRIPTION OF THE EMBODIMENTS

Various exemplary embodiments, features, and aspects of the invention will be described in detail below with reference to the drawings.

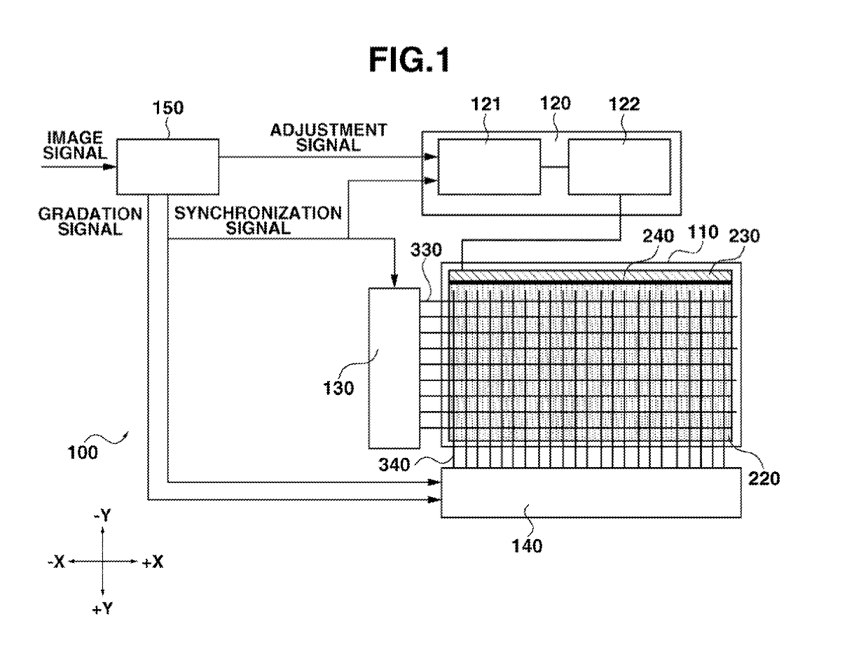

FIG. 1 is a schematic diagram illustrating an exemplary configuration of a display apparatus 100. Referring to FIG. 1, the display apparatus 100 includes a display panel 110, a potential generation circuit 120, a scanning circuit 130, and a modulation circuit 140. In addition, the display apparatus 100 can include a control circuit 150.

Among the components of the display apparatus 100, the display panel 110 will be described in detail now.

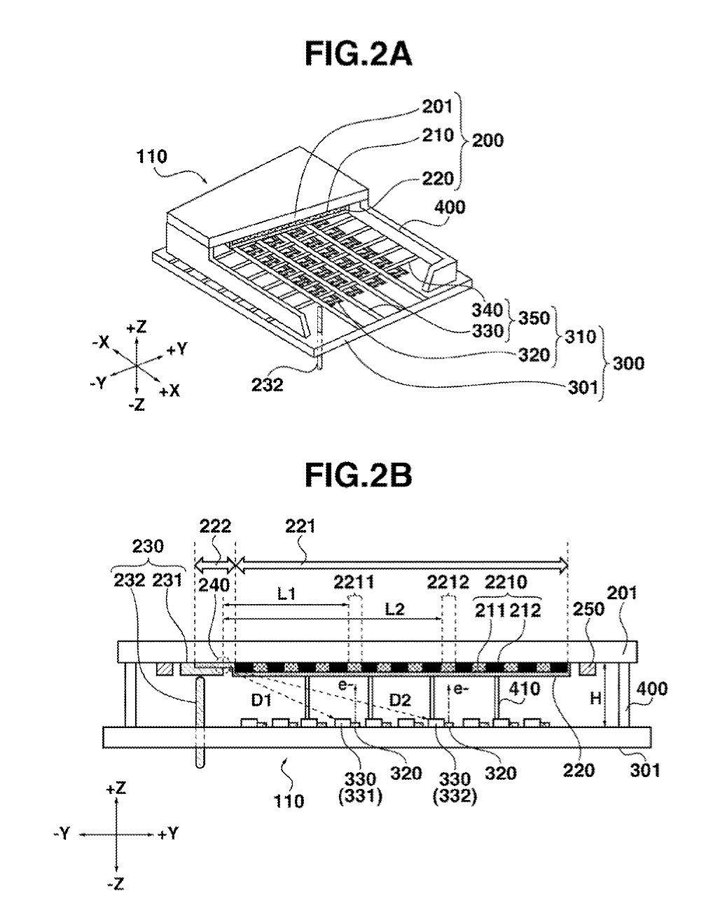

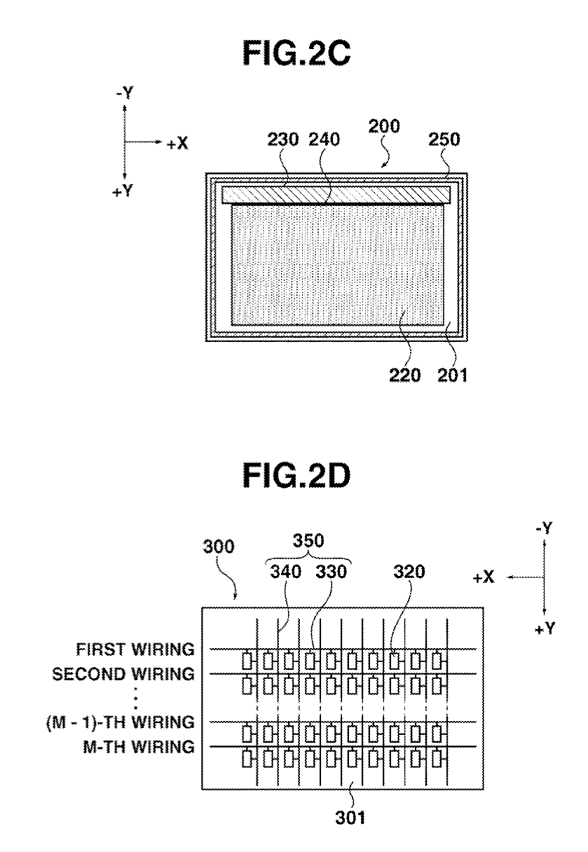

FIGS. 2A through 2D are schematic diagrams illustrating an exemplary configuration of the display panel 110 of an FED according to an exemplary embodiment of the present invention. More specifically, FIG. 2A is a partially cut-off perspective diagram of the display panel 110. FIG. 2B is a cross sectional view of the display panel 110. FIGS. 2C and 2D are exploded plan views of the display panel 110.

The display panel 110 includes a faceplate 200 and a rear plate 300, which are provided opposed to each other. The faceplate 200 includes a first substrate 201, which is transparent and insulating, a display member 210, and an anode 220. The display member 210 constitutes a display surface (screen) of the display apparatus 100. The display member 210 and the anode 220 are provided in the stack on the first substrate 201.

In the example illustrated in FIG. 2B, the display member 210 is provided between the first substrate 201 and the anode 220. However, alternatively, a transparent anode 220 can be provided between the first substrate 201 and the display member 210.

As illustrated in FIG. 2B, the display member 210 at least includes a light emitting layer 211. The light emitting layer 211 emits light when irradiated with an electron beam. In addition, the display member 210 can include a light-shielding layer 212, which can be provided between the light emitting layers 211.

The anode 220 is constituted by a single member or a composite member. The anode 220 can be largely divided into two regions, i.e., an irradiation target region 221 and an irradiation non-target region 222, which is a region external to the irradiation target region 221. The irradiation target region 221 of the anode 220 is a region in which the anode 220 is overlapping with the display member 210 (i.e., a region of the orthogonal projection of the display member 210). The large portion of the anode 220 is occupied by the irradiation target region 221.

The irradiation non-target region 222 of the anode 220 is a region of the anode 220 that is not overlapping with the display member 210. In addition, the irradiation non-target region 222 is an edge portion of the anode 220. In an exemplary embodiment of the present invention, the anode 220 is not a perfect conductor. To paraphrase this, the anode 220 has a resistance characteristic.

The rear plate 300 includes an insulating second substrate 301 and an electron source 310. The electron source 310 is provided on the second substrate 301. The electron source 310 includes a plurality of electron emitting devices 320, which are arranged in matrix, and a matrix wiring 350.

The matrix wiring 350 includes a plurality of row wirings 330 and a plurality of column wirings 340. In the matrix wiring 350, the plurality of row wirings 330 are projected in the same direction (in the X direction in the drawing) and are arrayed in a direction crossing the direction of projection of the plurality of row wirings 330 (in the Y direction in the drawing).

In the matrix wiring 350, the plurality of column wirings 340 are projected in the same direction (in the Y direction in the drawing) and are arrayed in a direction crossing the direction of projection of the plurality of column wirings 340 (in the X direction in the drawing). To paraphrase this, the plurality of row wirings 330 and the plurality of column wirings 340 cross one another. At an intersection of a row wiring 330 and a column wiring, an insulating layer (not illustrated) is provided to obtain isolation between the row wiring 330 and the column wiring 340.

Each of the plurality of electron emitting devices 320 is provided close to and connected to each of the plurality of row wirings 330 and each of the plurality of column wirings 340. More specifically, the electron emitting device 320 is provided at least one of a location on the row wiring 330, a location on the plurality of column wirings 340, a location between mutually adjacent row wirings 330, and a location between mutually adjacent column wirings 340.

In FIG. 2A, the electron emitting device 320 is provided between mutually adjacent row wirings 330 and between mutually adjacent column wirings 340. In the following description, as illustrated in FIG. 2D, “M” (M≧2) row wirings 330 are provided in the same direction as the direction of arrangement of the row wirings 330 (the Y direction) from a “−Y” side towards a “+Y” side. More specifically, the row wirings 330 are provided in order of a first row wiring 330, a second row wiring 330, (a third through an (M−2)-th row wirings 330,) an (M−1)-th row wiring 330, and an M-th row wiring 330. The portion of the display panel 110 in the “−Y” direction in the same direction as arrangement of the row wirings 330 (the Y direction) is referred to as an “upper portion” of the display panel 110. On the other hand, the portion of the display panel 110 in the “+Y” direction in the same direction as arrangement of the row wirings 330 (the Y direction) is referred to as a “lower portion” of the display panel 110.

The faceplate 200 and the rear plate 300 are connected to each other via a sealing member 400. The space between the faceplate 200 and the rear plate 300 (an internal space) is hermetically sealed by the sealing member 400. As a result, the first substrate 201, the second substrate 301, and the sealing member 400 constitute a hermetic chamber. The internal space of the hermetic chamber is maintained in a vacuum.

As described above, the display panel 110 is configured such that the electron source 310 and each of the anode 220 and the display member 210 are arranged opposing to one another inside the hermetic chamber. More specifically, the electron source 310 is opposed to the irradiation target region 221 of the anode 220. In the example illustrated in FIG. 2B, a spacer 410 is provided between the first substrate 201 and the second substrate 301 so that the hermetic chamber is appropriately resistant to the atmospheric pressure.

The display panel 110 includes a feeding member 230, which is connected to the anode 220. In the example illustrated in FIG. 2B, the feeding member 230 includes a feeding electrode 231 and a feeding terminal 232. The feeding member 230 is electrically connected to at least one part of the irradiation non-target region 222 (i.e., an edge portion) of the anode 220.

The feeding member 230 is provided to contact the irradiation non-target region 222 of the anode 220. The edge of a portion of the irradiation target region 221 in which the feeding member 230 and the anode 220 come in contact with each other is a joint portion 240 between the feeding member 230 and the anode 220. Accordingly, the joint portion 240 is located within the irradiation non-target region 222 of the anode 220.

In FIGS. 1 and 2C, the joint portion 240, which is indicated by a bold line in each drawing, is provided projecting in the same direction as the row wiring 330 is projecting (i.e., in the X direction). Furthermore, the joint 240 is provided only in the irradiation non-target region (the edge portion) 222 of the anode 220 in its upper portion (i.e., the portion of the anode 220 in the −Y direction).

Let “D” (D is a variable) be a distance from the joint 240 to each row wiring 330. More specifically, let a specific row wiring 330, which is provided at the distance D1 from the joint portion 240, be a first row wiring 331. And let a specific row wiring 330, which is provided at the distance D2 from the joint portion 240, be a second row wiring 332. To paraphrase this, the second row wiring 332 is more distant from the joint 240 than the first row wiring 331 (i.e., D1<D2).

For example, in the example illustrated in FIG. 1, if the first row wiring 331 is defined as a first row wiring, the second row wiring 332 is any one of a second through an M-th row wirings. On the other hand, if the first row wiring 331 is defined as an (M−1)-th row wiring, then the second row wiring 332 is an M-th row wiring. Because no row wiring that is more distant from the joint 240 than an M-th row wiring exists, an M-th row wiring cannot be the first row wiring 331.

An exemplary method for driving the display panel 110 will be described in detail below while also referring to an exemplary configuration of the display apparatus 100.

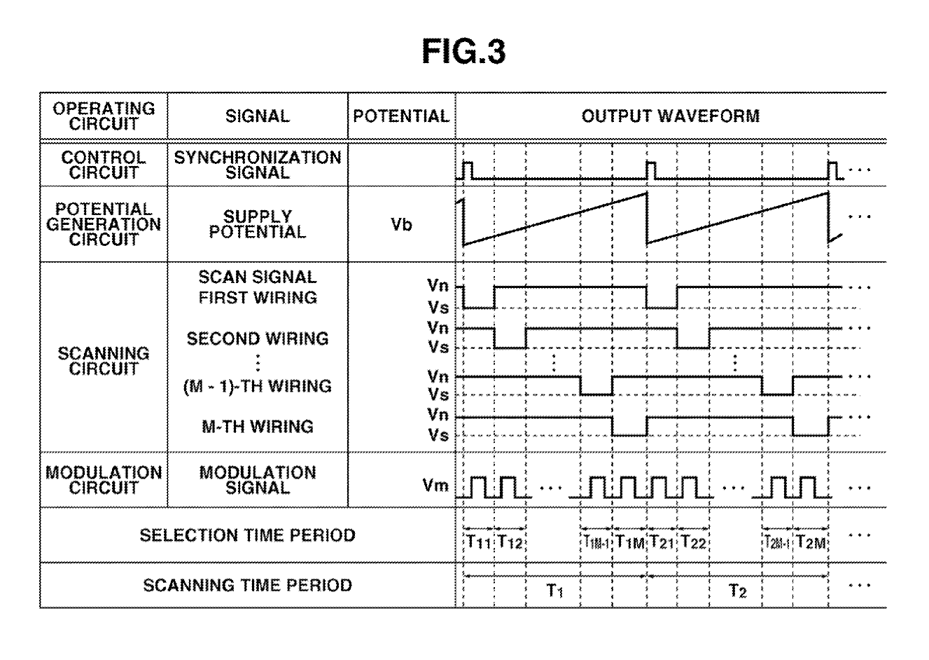

FIG. 3 is a schematic diagram illustrating an example of a signal used by the display apparatus 100 for driving the display panel 110. Referring to FIG. 3, the potential generation circuit 120 is connected to the feeding member 230 (e.g., to the feeding terminal 232) as illustrated in FIG. 1. The potential generation circuit 120 feeds a supply potential Vb to the feeding member 230 (the feeding electrode 231 and the feeding terminal 232).

As a result, the potential of the joint 240 becomes Vb. The supply potential Vb is higher than a potential of the electron source 310. The potential of the electron source 310 will be described in detail below.

A practical supply potential Vb can be equal to or between +1 kV and +50 kV. A more effective practical supply potential Vb can be equal to or between +3 kV and +30 kV. A yet more effective practical supply potential Vb can be equal to or between +5 kV and +15 kV. The potential generation circuit 120 of the present invention can generate a plurality of different supply potentials Vb.

In an exemplary embodiment of the present invention, “Vb1” denotes a first potential, which is a specific potential among a plurality of different supply potentials Vb, and “Vb2” denotes a second potential, which is higher than the first potential Vb1. The potential generation circuit 120 feeds the supply potential Vb to the feeding member 230. Accordingly, the anode 220, which is electrically connected to the feeding member 230, bears an anode potential Va.

The anode potential Va is higher than the potential of the electron source 310. A practical anode potential Va can be equal to or between +1 kV and +50 kV. A more effective practical anode potential Va can be equal to or between +3 kV and +30 kV. A yet more effective practical anode potential Va can be equal to or between +5 kV and +15 kV.

As described above, the anode potential Va is a high potential substantially as high as the supply potential Vb. Although detail will be described below, the anode potentials Va in specific timing are not even. In other words, the potentials Va are distributed due to the resistance characteristic of the anode 220.

By driving each of the plurality of electron emitting devices 320 via the matrix wiring 350 (i.e., by matrix driving), an electron (electron beam) can be emitted from an arbitrary position (i.e., from an arbitrary electron emitting device 320) on the electron source 310.

By applying a potential higher than the potential of the electron source 310 (i.e., the anode potential Va) to the anode 220, a potential difference (an anode voltage) between the potential of the electron source 310 and the anode potential may arise between the electron source 310 and the anode 220.

In addition, by utilizing an electric field generated by the anode voltage, the electron emitted from the electron source 310 is accelerated. In this manner, the energy is applied to an electron. Therefore, the anode voltage can be referred to as an “accelerating voltage” and the anode potential Va can be referred to as an “accelerating potential”.

Furthermore, the light emitting layer 211 is irradiated with the electron to which the energy is applied. Accordingly, the light emitting layer 211 emits light by electron beam excitation (cathode luminescence). As a result, a light emission portion is formed on the display member 210.

In an exemplary embodiment of the present invention, the luminance of the light emitted from the light emitting layer 211 is proportional to a current of the electron beam emitted from the electron emitting device 320 (an emission current Ie). The electron beam emitted from the electron source 310 is irradiated onto a part of the irradiation target region 221 of the anode 220. A part of the electron beam irradiation onto the irradiation target region 221 is absorbed by the anode 220.

The electron source 310 is driven by the scanning circuit 130 and the modulation circuit 140. Which electron emitting device 320 of those included in the electron source 310 is to be selected as an element to emit an electron is determined at least by the scanning circuit 130.

The scanning circuit 130 is connected to a plurality of row wirings 330. In addition, the scanning circuit 130 inputs a scan signal to the plurality of row wirings 330. The scanning circuit 130 selects a part of the plurality of row wirings 330 (typically, one row wiring 330) in one selection time period within one scanning time period based on the input scan signal. Furthermore, by scanning the selected plurality of row wirings 330, all of the plurality of row wirings 330 is selected once within one scanning time period.

The above-described “selection” is executed in the following manner. More specifically, a selection potential Vs is supplied to the row wiring 330 that has been selected within the selected time period. Furthermore, a non-selection potential Vn, which is different from the selection potential Vs, is supplied to another row wiring 330 that has not been selected.

In the following description, the row wiring 330 to which the selection potential Vs has been supplied, among the plurality of row wirings 330, is referred to as a “selected wiring”. On the other hand, the row wirings 330 to which the non-selection potential Vn has been supplied, among the plurality of row wirings 330, is referred to as an “unselected wiring”. The above-described “scanning” is executed by changing the selected wiring for each different selection time period within one scanning time period.

The modulation circuit 140 is connected to the plurality of column wirings 340. The modulation circuit 140 inputs a modulation signal to the plurality of column wirings 340. Furthermore, in the modulation circuit 140, the input modulation signal has a modulation potential Vm. The modulation circuit 140 supplies the modulation potential Vm to a part of or all of the plurality of column wirings 340 (typically, to all of the plurality of column wirings 340) within the selection time period.

A potential difference between the modulation potential Vm and the selection potential Vs (i.e., a driving voltage Vd) is applied to each electron emitting device 320, which is connected to the selected wiring. As a result, the electron of a quantity equivalent to a result of the following expression for calculating the driving voltage Vd is emitted:

Vd=|Vm−Vs|.

The quantity of the electron to be emitted is the emission current Ie.

On the other hand, a potential difference between the modulation potential Vm and the non-selection potential Vn arises on each electron emitting device 320, which is connected to the non-selected wiring. However, the non-selection potential Vn is set to restrict the voltage to a level at which the electron emitting device 320 can be regarded as substantially not emitting any electron (a threshold voltage) or to a lower level. Therefore, it can be regarded that electron beams are emitted only from the electron emitting devices connected to the selected wiring within one selection time period.

The potential of the electron source 310 is determined by the potential of the above-described scan signal and the potential of the above-described modulation signal (the selection potential Vn, the non-selection potential Vs, and the modulation potential Vm). Typically, the selection potential Vn, the non-selection potential Vs, and the modulation potential Vm are within ±100 V relative to the ground potential (0 V). More effective selection potential Vn, non-selection potential Vs, and modulation potential Vm are within ±20 V relative to the ground potential. The potential of the electron source 310 is the highest among the above-described potentials.

The control circuit 150 is connected to the potential generation circuit 120, the scanning circuit 130, and the modulation circuit 140. An image signal is input to the control circuit 150. The control circuit 150 outputs a synchronization signal (i.e., synchronous idle (SYN)) and a gradation signal according to the input image signal.

The gradation signal is input to the modulation circuit 140. The modulation circuit 140 modulates the input gradation signal by a predetermined modulation method. Then the modulation circuit 140 outputs a modulation signal.

The synchronization signal is input to the scanning circuit 130. The scanning circuit 130 outputs a scan signal according to the input synchronization signal. More specifically, the synchronization signal controls the timing of starting one scanning time period and each selection time period. In addition, the synchronization signal is also input to the modulation circuit 140. In synchronization with each selection time period, the modulation circuit 140 outputs a desired modulation potential to generate a desired level of emission current from the electron emitting device 320 that is connected to the selected wiring.

In the above-described manner, all of row wirings 330 are line-sequentially scanned within one scanning time period. As a result, light emission portions are line-sequentially formed in one scanning time period and one image (an image of one frame) is displayed in one scan period. Accordingly, one scanning time period can be paraphrased as “one frame period”.

In the present invention, the term “line-sequential scan” is used to clearly differentiate the same from the “frame sequential scan”. To paraphrase this, in the present invention, the term “line-sequential scan” is different from a term “progressive scan”, which is often referred to also as “line-sequential scan” to differentiate between the progressive scan and “interlace scan”.

In the progressive scan method, mutually adjacent row wirings 330 are sequentially selected from the upper portion towards the lower portion of the display panel 110 in order of arrangement of the row wirings 330 within one scanning time period. As a result, an image of one frame is displayed starting from the top towards the bottom of the image. In this manner, an image is displayed in a progressive display.

In an interlace scan there are an odd-numbered field and an even-numbered field in one frame. More specifically, in an odd-numbered field, odd-order row wirings 330 are sequentially selected starting from the top of the display panel towards the bottom, in order of arrangement of the row wirings 330. In an even-numbered field, even-order row wirings 330 are sequentially selected starting from the top of the display panel towards the bottom, in order of arrangement of the row wirings 330. As a result, odd-numbered fields and even-numbered fields are combined together to be displayed as an image of one frame. In the above-described manner, the image of one frame is displayed by an interlace display method.

The above-described “line-sequential scan” includes both the progressive scan and the interlace scan methods, in which the row wirings 330 are selected in order of arrangement of the row wirings 330. In addition, the “line-sequential scan” also includes a method in which the row wirings 330 are selected not in order of arrangement of the row wirings 330 (i.e., a method in which the row wirings 330 are selected at random).

In the present invention, a selection time period for selecting the first row wiring 331 is referred to as “first selection time period TSL1”. On the other hand, a selection time period for selecting the second row wiring 332 is referred to as “second selection time period TSL2. Both the first selection time period TSL1 and the second selection time period TSL2 are within a first scanning time period TSC.

In selecting a plurality of row wirings 330 in order of the shortest distance from the joint 240 (i.e., in scanning from a first row wiring towards an M-th row wiring), the second selection time period TSL2 comes after the first selection time period TSL1. On the other hand, in selecting a plurality of row wirings 330 in order of the longest distance from the joint 240 (i.e., in scanning from an M-th row wiring towards a first row wiring), the second selection time period TSL2 comes before the first selection time period TSL1.

In the present invention, a first potential Vb1, of the supply potential Vb, is supplied to the feeding member 230 in the first selection time period TSL1. On the other hand, a second potential Vb2, of the supply potential Vb, is supplied to the feeding member 230 is the second selection time period TSL2.

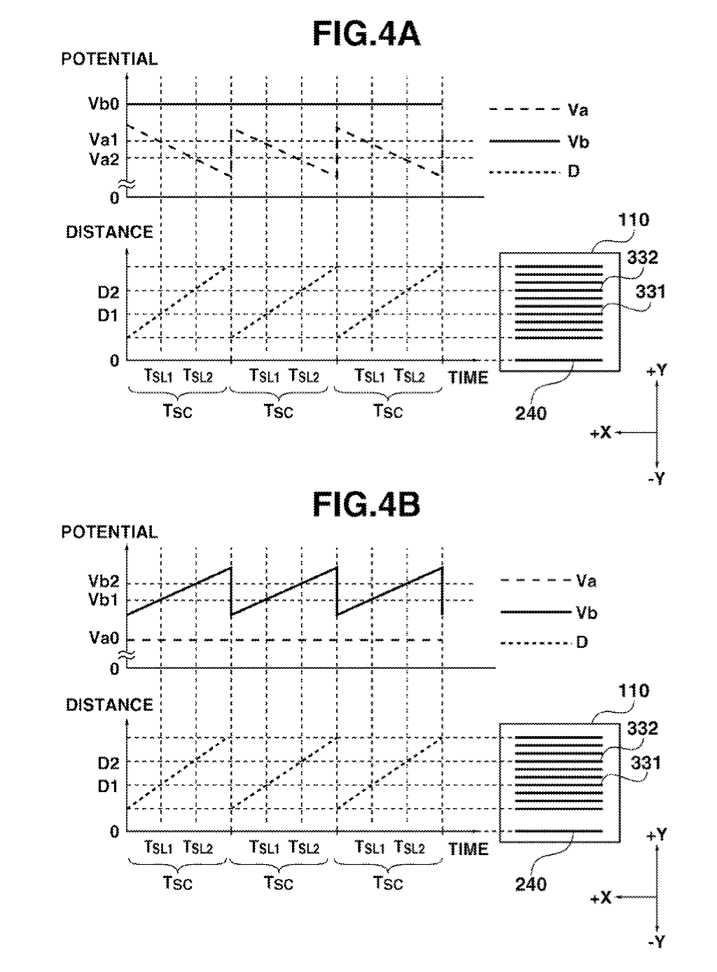

With the above-described configuration, the present invention can effectively reduce display unevenness, which may occur on the display surface, because of the following reasons. The reasons will be described below with reference to FIGS. 2B, 4A, and 4B.

The first selection time period TSL1 and the second selection time period TSL2 are a period having a specific length of time. However, in FIGS. 4A and 4B, only timings thereof are illustrated but the specific length of time is not illustrated for easier understanding. Furthermore, in FIGS. 4A and 4B, for the display panel 110, only a positional relationship between the joint 240 and the row wiring (the first row wiring 331 and the second row wiring 332) is schematically illustrated for easier understanding.

The electron beams emitted in each selection time period form an irradiation target portion at an arbitrary position in the irradiation target region 221 of the anode 220. The irradiation target portion is located approximately close to a location on the anode 220 at which the distance from the selected wiring to the anode 220 becomes shortest. Specifically, the irradiation target portion is approximately located at a location close to a location on the anode 220 at which the distance from the electron emitting device 320 that is connected to the selected wiring to the anode 220 becomes shortest.

Because the irradiation target portion and the light emission portion are overlapping with each other, the location of the irradiation target portion can be easily confirmed as the light emission portion of the display member 210. Accordingly, the location of the irradiation target portion and the location of the light emission portion can be regarded substantially the same within an X-Y plane (i.e., within a plane parallel to the display surface). In addition, the irradiation target portion has a linear shape, which is similar to the pattern of arrangement of the electron emitting devices 320, which are connected to the first row wiring 331 and the second row wiring 332.

Let “L” be the distance from the irradiation target portion (or the light emission portion) to the joint portion 240 in each selected time period and “H” be the distance from the electron source 310 to the anode 220 (i.e., an interval H between the faceplate 200 and the rear plate 300). The distance H is typically equal to or less than 5 mm and the dimension of the display panel 110 in the Y direction is typically equal to or greater than 5 cm. Therefore, practically, the distances D and L can be regarded as substantially the same according to the following expression:

D=√(H²+L²)=L√(H²/L²+1)L.

where in particular, as illustrated in FIG. 2B, “L1” (D1) denotes the distance from a first irradiation target portion 2211 to the joint portion 240. The first irradiation target portion 2211 is a target of irradiation with the electron beam emitted from the electron emitting device 320 connected to the first row wiring 331 in the first selection time period TSL1. “L2” (D2) denotes the distance from a second irradiation target portion 2212 to the joint portion 240. The second irradiation target portion 2212 is a target of irradiation with the electron beam emitted from the electron emitting device 320 connected to the second row wiring 332 in the second selection time period TSL2.

A part of the electron beams emitted from the electron emitting device 320 is absorbed by the anode 220. Accordingly, an anode current Ia, which is of substantially the same level as the emission current Ie, flows from the feeding member 230 towards the irradiation target portion of the anode 220. Because the anode 220 has a certain level of resistance, a potential difference ΔVa may arise between the irradiation target portion and the joint portion 240 due to the anode current Ia. Therefore, the anode potential Va of the irradiation target portion of the anode 220 can be expressed as:

Va=Vb−ΔVa.

The anode potential Va of the irradiation target portion of the anode 220 can also be expressed as:

ΔVa=R×Ia

where “R” denotes a specific resistance of the anode 220. The resistance value R of the anode 220 is proportional to the resistance value of the anode 220 and the distance L between the irradiation target portion and the joint portion 240. Furthermore, the resistance value R of the anode 220 can be expressed by the following expression:

R=rL

where “r” is a constant or a function of the distance L. More specifically, the term “r” denotes a resistance value of a portion between the irradiation target portion and the joint portion 240 per unit length.

As described above, the location of the irradiation target portion and the light emission portion correspond to the location of the selected wiring and the electron emitting device 320 connected to the selected wiring. Accordingly, the resistance R is proportional to distance D between the selected wiring and the joint portion 240.

In addition, as described above, the location of the irradiation target portion and the light emission portion are different for each selection time period by scanning of the scanning circuit 130. Therefore, the distance D and the distance L may temporally vary. More specifically, if the scan starts from the row wiring 330 located close to the joint portion 240 in order of short distance from the joint portion 240, the distance D and the distance L may increase as the scan progresses. On the other hand, if the scan starts from the row wiring 330 located distant from the joint portion 240 in order of long distance from the joint portion 240, the distance D and distance L may decrease as the scan progresses.

In addition, in the present invention, the variation of the distance D between the joint portion 240 and the selected wiring and the variation of the distance L between the joint portion 240 and the irradiation target portion and the light emission portion are associated with the variation of the supply potential Vb. Furthermore, by temporally controlling the supply potential Vb, the distribution of the anode potential Va, which may spatially arise due to the resistance characteristic of the anode 220, can be substantially suppressed or reduced.

In the first selection time period TSL1, an anode potential Va1 of the first irradiation target portion 2211 can be expressed by the following expression:

Va1=Vb1−ΔVa1=Vb−rL1Ia.

In the second selection time period TSL2, an anode potential Va2 of the second irradiation target portion 2212 can be expressed by the following expression:

Va2=Vb−ΔVa2=Vb−rL2Ia.

In the following description, it is supposed that the r is a constant and that the anode current Ia is constant for each selection time period. In this case, rL1Ia<rL2Ia because L1<L2.

In the example illustrated in FIG. 4A, the supply potential Vb is constant at Vb0. In the first selection time period TSL1, in which the supply potential Vb0 is supplied to the feeding member 230, the anode potential Va1 of the first irradiation target portion 2211 can be expressed by the following expression:

Va1=Vb0−ΔVa1=Vb0−rL1Ia.

In the second selection time period TSL2, in which the supply potential Vb0 is supplied to the feeding member 230, the anode potential Va2 of the second irradiation target portion 2212 can be expressed by the following expression:

Va2=Vb0−ΔVa2=Vb0−rL2Ia.

In this case, Va1>Va2 because rL1Ia<rL2Ia.

In the example illustrated in FIG. 4B, a case is illustrated where the first potential Vb1 and the second potential Vb2 (Vb1<Vb2) are output from the supply potential Vb.

In the first selection time period TSL1, in which the first potential Vb1 is supplied to the feeding member 230, the anode potential Va1 of the first irradiation target portion 2211 can be calculated by the following expression:

Va1=Vb1−ΔVa1=Vb1−rL1Ia.

In the second selection time period TSL2, in which the second potential Vb2 is supplied to the feeding member 230, the anode potential Va2 of the second irradiation target portion 2212 can be expressed by the following expression:

Va2=Vb2−ΔVa2=Vb2−rL2Ia.

Because Vb1<Vb2, the difference between Va1 and Va2 becomes smaller than that in a case where Vb is constant at Vb0 (FIG. 4A). Accordingly, the difference of levels of the energy given to the electron emitted from the electron emitting device 320 that is connected to the selected wiring for each selection time period becomes small. Therefore, the difference between the levels of luminance of the light emitted from the light emitting layer 211 may become small. As a result, the present invention can suppress or reduce the display unevenness.

Vb1 and Vb2 can be set to have a relationship expressed as follows:

Vb2−Vb1=r=(L2−L1)Ia.

If the supply potential Vb is set to satisfy the above-described expression, a condition Va1=Va2 can be satisfied.

If the second potential Vb2 is extremely greater than the first potential Vb1, the anode potential Va may become more distributed. To prevent this, the first potential Vb1 and the second potential Vb2 can have a relationship expressed by the following condition to achieve a more useful example:

0<Vb2−Vb1<2r(L2−L1)Ia.

If the above-described condition is satisfied for all the row wirings 330, the present invention can be more useful. However, the present invention can be sufficiently useful if the above-described condition is satisfied for a minimum value of L (Lmin) and a maximum value of L (Lmax).

More specifically, the present invention can be useful if above-described condition is satisfied for L1=Lmin and L2=Lmax when a row wiring 330 that is located the closest to the joint portion 240 is set as the first row wiring 331 and a row wiring that is located the most distant from the joint portion 240 is set as the second row wiring 332. In this case, the luminance of the light emitted from the light emission portion of the light emitting layer 211 becomes saturated if the anode potential Va becomes great. Accordingly, unless the above-described condition is precisely satisfied, i.e., if Vb2−Vb1≧2r(L2−L1)Ia, the present invention in this case can more effectively suppressor reduce display unevenness than in a case where the supply potential Vb is constant.

If the value of the anode current Ia is replaced with a value of the emission current Ie, the display unevenness can be suppressed at a sufficiently high accuracy. In particular, the present invention is more useful if the value of the anode current Ia is replaced with a value of the emission current Ie when the luminance of the light emission portion is between 25 and 75% of a maximum luminance. The present invention can become yet more useful if the value of the anode current Ia is replaced with a value of the emission current Ie when the luminance of the light emission portion becomes 50% of the maximum luminance.

In the description above, two supply potential values including the first potential Vb1 and the second potential Vb2 are used. However, the present invention can be more useful if the potential generation circuit 120 further outputs a supply potential different from the first potential Vb1 or the second potential Vb2. For example, the potential generation circuit 120 can supply a supply potential in between the first potential Vb1 and the second potential Vb2 to the feeding member 230 in a selection time period for selecting the row wiring 330 that is located between the first row wiring 331 and the second row wiring 332.

More specifically, in a selection time period for selecting the row wiring 330 located closer to the joint portion 240 than the first row wiring 331, the potential generation circuit 120 can supply a supply potential lower than the first potential Vb1 to the feeding member 230. On the other hand, in a selection time period for selecting the row wiring 330 located more distant from the joint portion 240 than the second row wiring 332, the potential generation circuit 120 can supply a supply potential higher than the second potential Vb2 to the feeding member 230.

In addition, the supply potential Vb can be controlled in the unit of a row wiring group, which is generated by grouping the row wirings 330 into a plurality of row wiring groups, each of which including a plurality of row wirings, according to the distance to the joint portion 240. In this case, for example, the row wirings 330 can be grouped into three row wiring groups, such as a first row wiring group including the first row wiring 331, a second row wiring group including the second row wiring 332, and a third row wiring group located between the first and the second row wiring groups.

In this case, in each selection time period for selecting each of the row wirings included in the first row wiring group, the potential generation circuit can supply the first potential Vb1 to the feeding member 230. In addition, in each selection time period for selecting each of the row wirings included in the second row wiring group, the potential generation circuit can supply the second potential Vb2 to the feeding member 230. Then, in each selection time period for selecting each row wiring included in the third row wiring group, the potential generation circuit can supply a supply potential in between the first potential Vb1 and the second potential Vb2.

To control the anode potential Va of the irradiation target portion with higher accuracy, the supply potential Vb can vary for each selection time period for selecting a each row wiring 330. In other words, the potential generation circuit 120 can discretely (in stages) change and output the supply potential of the same numeric level (peak value) as many as the number M of the row wirings 330. Alternatively, the potential generation circuit 120 can sequentially change a plurality of supply potentials and output the resulting supply potentials. If the latter method for sequentially changing a plurality of supply potentials is used, the potential generation circuit 120 can be implemented with a simpler configuration.

As described above the phenomenon of distributed anode potentials Va can be effectively suppressed by increasing the supply potential Vb as the distance D between the joint portion 240 and the selected wiring increases, i.e., as the distance L between the joint portion 240 and the irradiation target portion and the light emission portion increases.

Similarly, the phenomenon of distributed anode potentials Va can be effectively suppressed by causing the supply potential Vb to decrease as the distance D between the joint portion 240 and the selected wiring decreases, i.e., as the distance L between the joint portion 240 and the irradiation target portion and the light emission portion decreases,

Now, an exemplary configuration of the display panel 110 will be described in detail below.

In the present invention, a conductor, a resistor, and an insulator are defined according to a relative magnitude relation of specific resistance of each element when the elements contact one another. More specifically, if a conductor, a resistor, and an insulator contact one another, the specific resistance becomes great in this order, (i.e., the specific resistance of the conductor<the specific resistance of the resistor<the specific resistance of the insulator).

For practical use, if the volume specific resistance of a material is 10⁻⁵Ωm or lower, the material can be defined as a conductor. If the volume specific resistance of a material is 10⁸Ωm or higher, the material can be defined as an insulator. If the volume specific resistance of a material is higher than 10⁻⁵Ωm and lower than 10⁸Ωm, the material can be defined as a resistor.

Similarly, in the present invention, a conductive film, a resistance film, and an insulating film are defined by a relative magnitude relation of sheet resistance value of each film when the films contact one another. More specifically, if a conductive film, a resistance film, and an insulating film contact one another, the sheet resistance value thereof becomes great in the above-described order (i.e., the sheet resistance value of the conductive film<the sheet resistance value of the resistance film<the sheet resistance value of the insulating film).

For practical use, if the sheet resistance value of a film is 10 ohm/square (Ω/□) or lower, the film can be regarded as a conductive film. If the sheet resistance value of a film is 10¹⁴Ω/□ or higher, the film can be regarded as an insulating film. If the sheet resistance value of a film is higher than 10Ω/□ and lower than 10¹⁴Ω/□, the film can be defined as a resistance film.

For the light emitting layer 211 of the display member 210, a material that emits light by the electron beam excitation can be used. Typically, a phosphor layer can be used. More specifically, as the material of the phosphor layer, a phosphor crystal material used for a conventional cathode ray tube (CRT), which is described in “Handbook of Phosphor Material”, edited by Keikotai Dogakkai (Institute of Phosphor Material Studies), issued by Ohmsha, Ltd., can be used.

The thickness of a phosphor material can be appropriately set according to an accelerating voltage, a grain size of a phosphor particle, and a packing density of the phosphor. If the accelerating voltage is within a range of 5 kV to 15 kV, the thickness of the phosphor layer can be set within a range of about 4.5 μm to 30 μm, which is larger than an average grain size of a general phosphor material (3 μm to 10 μm) by one and a half times to three times. More effectively, the thickness of the phosphor layer can be set within a range of about 5 μm to 15 μm.

For the light-shielding layer 212 of the display member 210, a black matrix or a black stripe, which has been publicly known for a material used for a CRT, can be used. The light-shielding layer 212 is generally constituted by a black metal, black metal oxide, or carbon. For the black metal oxide, ruthenium oxide, chromium oxide, iron oxide, nickel oxide, molybdenum oxide, cobalt oxide, or copper oxide can be used.

The display member 210 can include a color filter (not illustrated) in addition to the light emitting layer 211 and the light-shielding layer 212. More specifically, a color filter can be provided between the light emitting layer 211 and the first substrate 201. If the anode 220 is provided on the display member 210 of the electron source 310 side, it is required that at least apart of the electron beams may go through the anode 220 to irradiate the light emitting layer 211. Therefore, a thin film as thin as 1 μm or thinner is used as the anode 220.

The film thickness of the anode 220 is appropriately set according to the amount of electron energy loss and the anode potential Va. More specifically, if the anode potential Va comes within the range of 5 kV to 15 kV, the film thickness of the anode 220 is set within the range of 50 nm to 300 nm. If a thin film like this is used as the anode 220, the anode 220 has a resistance characteristic.

If the anode 220 is provided between the display member 210 and the first substrate 201, a transparent conductive film is used for the anode 220 because it is required that the anode 220 is transparent in this case. However, a common transparent conductive film, such as indium tin oxide (ITO) or antimony-doped indium tin oxide (ATO), has a specific resistance higher than that of a common conductive film, such as a metal film. Therefore, the anode 220 has a resistance characteristic. The resistance characteristic of the anode 220 can be set high unless the distribution of the anode potentials Va does not become extremely intense due to the resistance characteristic of the anode 220 itself.

A high electric field is generated between the faceplate 200 (the anode 220) and the rear plate 300 (the electron source 310) by the anode potential Va. Accordingly, an unintended discharge may occur between the faceplate 200 and the rear plate 300. A current (discharge current) may flow in the electron source 310 by the discharge.

If a discharge current is large, the electron source 310, the scanning circuit 130, or the modulation circuit 140 may be damaged. The amount of the discharge current can be reduced by increasing the resistance characteristic of the anode 220.

More specifically, the sheet resistance of the irradiation target region 221 of the anode 220 can be set to 100Ω/□ or higher. To more effectively implement the present invention, the sheet resistance of the irradiation target region 221 of the anode 220 can be set to 100 kΩ/□ or higher.

The sheet resistance of the anode 220 can be measured by causing a pair of electrodes, which has a predetermined length w, to contact the anode 220 separated at a distance of predetermined length l in the direction of arrangement of the row wiring 330 (the Y direction). Specifically, the resistance value R can be calculated by the following expression:

R=V/I

where “I” denotes the current that flows when a voltage V is applied to a pair of electrodes. A value calculated in the following manner can be used as a sheet resistance Rs. More specifically, at first, an expression “R×w/l” is executed. If the values w and l are increased, the result of the expression “R×w/l” may become substantially constant. The value resulting in this timing can be used for the sheet resistance Rs.

In the above-described manner, even if the anode 220 is constituted by a composite member which includes repeatedly arranged constituent units, the sheet resistance Rs can be appropriately calculated.

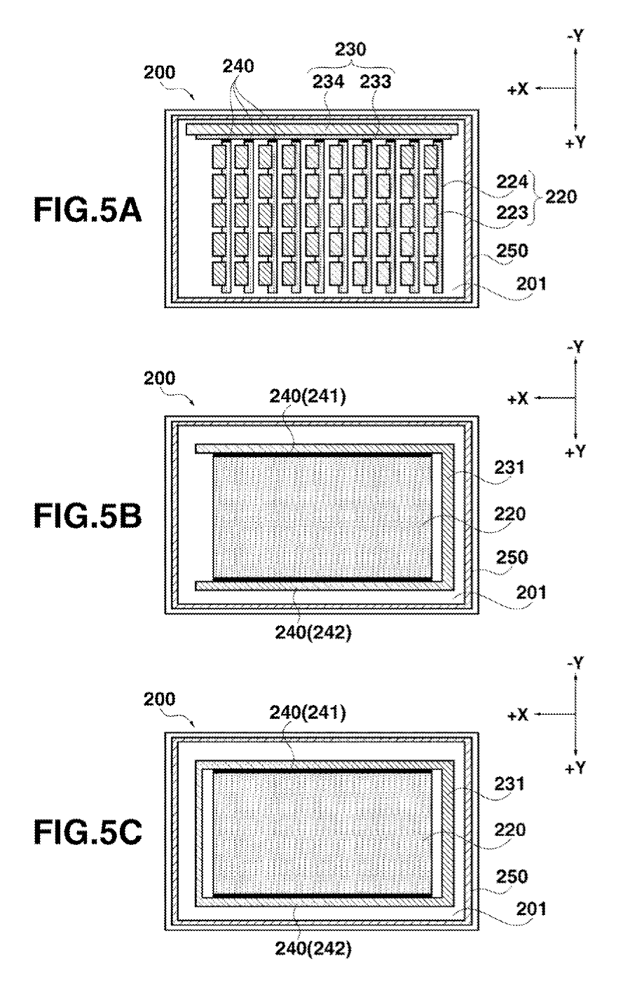

To set a desired value to the resistance characteristic of the anode 220, the irradiation target region 221 of the anode 220 can be constituted by a plurality of conductive films 223 and a resistive film 224, which mutually connects plurality of conductive films 223, as illustrated in FIG. 5A. A configuration like this is discussed in Japanese Patent Application Laid-Open No. 2006-012062 and Japanese Patent Application Laid-Open No. 2005-235470.

By the resistive film 224, even if a discharge has occurred at any location on the anode 220, the concentration of the discharge current at the location of the discharge can be effectively prevented. In this case, the resistance value between the conductive films 223, which exist adjacent to each other via the resistive film 224, can be set equal to or between 1 kΩ and 1 MΩ. It is more useful if the resistance value between the conductive films 223, which exist adjacent to each other via the resistive film 224, is set equal to or between 100 kΩ and 1 MΩ.

In the example illustrated in FIG. 5A, the resistive film 224 connects the conductive films 223 together in the Y direction. However, alternatively, the conductive films 223 can be connected together by the resistive film 224 in the X direction. The resistance value of the anode 220 in the Y direction can be increased by providing the resistive film 224 at least in the Y direction. With the above-described configuration, the present invention can securely achieve a high effect of suppressing or reducing the distribution of the anode potentials in the Y direction.

The above described resistive film 224 of the anode 220 can be provided on the light-shielding layer 212. However, alternatively, the light-shielding layer 212 itself can be constituted by a resistor. In this case, the light-shielding layer 212 can be used as the resistive film 224. More specifically, in this case, the light-shielding layer 212 can implement a part of the functions of the display member 210 and a part of the functions of the anode 220 at the same time.

If the anode 220 is provided on the display member 210 of the electron source 310 side, a metal film, such as an aluminum film, can be used as the anode 220. The metal film like this is generally referred to as a metal back. In the present invention, the metal includes an alloy in addition to an elemental metal.

The metal back can reflect light emitted from the light emitting layer 211 towards an observer (user) by utilizing the light reflex capability of the metal film provided on the light emitting layer 211 of the electron source 310 side. Because the metal back is required to be a thin film, the metal back has a certain level of resistance characteristic although it is the metal film. The metal back can be formed by stacking a continuous metal film on the entire display member 210. However, to prevent the concentration of and reduce the amount of the discharge current, the resistive film 224 can connect between the metal film layers by the metal film (metal back) as the plurality of conductive films 223.

The feeding member 230 can include the feeding terminal 232, which is a stick-like (pin-like) member including the feeding electrode 231, which is a conductive film, and a conductor. The feeding electrode 231, which is provided on the first substrate 201 and contacts the anode 220, constitutes the joint portion 240. The feeding terminal 232 penetrates through the second substrate 301 and comes in contact with the feeding electrode 231 inside the hermetic chamber.

In the above-described manner, the feeding member 230 is electrically connected with the anode 220 externally from the hermetic chamber. Alternatively, the feeding terminal 232 can directly contact the anode 220 by omitting the feeding electrode 231 of the feeding member 230. Further alternatively, the feeding electrode 231 can be projected out of the hermetic chamber if the feeding terminal 232 of the feeding member 230 is omitted.

If the same material as the material of the anode 220 is used for the feeding electrode 231 and if the feeding electrode 231 is connected to the anode 220, the joint 240 between the feeding electrode 231 and the anode 220 cannot be explicitly defined. In this case, the irradiation non-target region 222 of the anode 220 can be regarded as the feeding electrode 231 and a boundary between the irradiation target region 221 and the irradiation non-target region 222 can be regarded as the joint portion 240.

The feeding member 230 can have the conductivity property at which the supply potential Vb can be sufficiently supplied to the anode 220. More specifically, to decrease the voltage drop on the feeding member 230 itself, which may occur when a high voltage is supplied from the potential generation circuit 120, it is useful if a portion of the joint portion 240, from a portion connecting with the potential generation circuit 120 to a portion that is electrically most distant from the potential generation circuit 120, has a low resistance value.

More specifically, it is useful to set the resistance value of the portion of the joint portion 240, from a portion connecting with the potential generation circuit 120 to a portion that is electrically most distant from the potential generation circuit 120, at 1 kΩ or lower.

In addition, a resistance portion 233 can be provided on apart of the feeding member 230 (in particular, the feeding electrode 231). Furthermore, the resistance portion 233 can be provided in a portion of the feeding electrode 231 contacting the anode 220 so that the resistance portion 233 contacts the anode 220 to constitute the joint portion 240.

With the above-described configuration, if a discharge has occurred at a location on the anode 220 close to the joint portion 240 of the feeding electrode 231, a discharge current can be effectively prevented from becoming larger. This can be achieved because the resistance portion 233 can restrict a flow of electric charges, which have been charged on the feeding electrode 231, into the rear plate 300 as the discharge current.

In this case, for the feeding member 230 (the feeding electrode 231), the present invention can be more effective if the resistance value of the feeding member 230 itself is low and the portion between the feeding member 230 and the anode 220 has a high resistance value at the same time. To implement this configuration, the feeding member 230 can include the resistance portion 233 and a conductive portion 234.

For example, the feeding electrode 231 can be constituted by a resistance film, which constitutes the resistance portion 233 and which is connected to the irradiation non-target region 222 of the anode 220, and a conductive film, which constitutes the conductive portion 234 and which is connected to the resistance portion 233. In this case, the resistance value of the resistance portion 233 between the anode 220 and the conductive portion 234 can be set equal to or between 1 MΩ and 1 MΩ.

The conductive film of the conductive portion 234 of the feeding electrode 231 can be a continuous film. Alternatively, a mutually separate plurality of conductive films, which is discussed in Japanese Patent Application Laid-Open No. 2006-185614, can be used.

The feeding terminal 232 penetrates through the second substrate 301 and is fixed onto the second substrate 301. Accordingly, the feeding terminal 232 can have a coefficient of thermal expansion (CTE) substantially similar to the CTE of the second substrate 301 (i.e., within a range of ±20% thereof). Typically, an alloy, such as a 426 alloy or an invar alloy, which contains Fe and Ni (provided that the content of Ni<the content of Fe), can be used as the feeding terminal 232.

The joint portion 240 can be provided at a location at which the distance from each row wiring 330 can be different for each row wiring 330. Furthermore, the joint portion 240 can be provided in a shape like a solid line or a broken line. In particular, the joint portion 240 can be projected in the same direction as the projection of the row wiring 330 (the X direction). With the above-described configuration, the present invention can effectively prevent or reduce the distribution of the anode potentials Va in the same direction as the direction of projection of the row wiring 330 (the X direction).

Alternatively, the joint portion 240 can be provided on one side of the anode 220 parallel to the row wiring 330 only (i.e., only in the irradiation non-target region 222 of the anode 220, which is provided in the upper portion or the lower portion of the anode 220 (on one edge thereof only)). Further alternatively, the joints portion 240 can be provided on two sides of the anode 220, which are parallel to the row wiring 330 and opposing each other, i.e., in both irradiation non-target regions (both upper and lower edges) 222 in the Y direction.

FIGS. 5B and 5C illustrate a configuration in which the joints 240 are provided on two edges of the anode 220. In each drawing, a first joint portion 241 and a second joint portion 242 are illustrated.

In the example illustrated in FIG. 5B, the feeding electrodes 231 are provided on three edges of the anode 220 and the joint portions 240 are provided on two edges of the anode 220. In the example illustrated in FIG. 5C, the feeding electrodes 231 are provided on the four edges of the anode 220 in a surrounding manner. In addition, the joint portions 240 are provided on two edges of the anode 220, i.e., on the upper and the lower edges.

In each of the examples illustrated in FIGS. 5B and 5C, the feeding electrodes 231 are projected between the upper edge and the lower edge of the anode 220. In this state, the joint portions 240 are provided on two edges of the anode 220. However, alternatively, different feeding electrodes 231 are provided on two edges of the anode 220 and a feeding terminal 232 can be connected to each of the feeding electrodes 231. In this case, the output of the potential generation circuit 120 can be split to each feeding terminal 232.

If a plurality of joint portions 240 is provided as described above, at least one of the row wirings 330, which are provided on both edges in the direction of arrangement of the row wiring 330 (the Y direction), becomes the row wiring 330 closest to the joint portion 240.

When arbitrary two row wirings 330 of the plurality of row wirings 330 are compared, a row wiring 330, whose distance from one of the first joint portion 241 and the second joint portion 242 is shorter is the first row wiring 331. For example, a case will be described where ninety-nine row wirings 330 are arranged between the first joint portion 241 and the second joint portion 242 at equal interval.

Take a thirtieth row wiring from the first joint portion 241 and a sixtieth row wiring from the second joint portion 242. In this case, the thirtieth row wiring from the first joint portion 241 is the first row wiring 331 and the sixtieth row wiring from the second joint portion 242 is the second row wiring 332. Furthermore, a fiftieth row wiring is a row wiring whose distance from the first joint portion 241 and the second joint portion 242 is the longest of all the row wirings 330.

Accordingly, in this exemplary case, the highest supply potential Vb can be supplied to the feeding member 230 within the selected time period in which the fiftieth row wiring becomes the selected wiring. In addition, it is useful if a guard electrode 250, which is an electrode regulated at a potential lower than the anode potential Va, is provided between the anode 220 or the feeding member 230, which is regulated at the high potential (Va and Vb), and the sealing member 400. In addition, the potential of the guard electrode 250 can be set at the ground potential (0 V).

Due to the high potential of the anode 220, the potential distribution may arise on the surfaces of the sealing member 400 and the first substrate 201 as well as in a portion between the faceplate 200 and the rear plate 300. To prevent this, the guard electrode 250, which is regulated at a low potential can be provided so that the potential of a region, which is located in the other side of the anode 220 across the guard electrode 250, can be restricted to be lower than the anode potential. The guard electrode 250 can be provided in a loop-like shape surrounding the anode 220 and the feeding member 230 (the feeding electrode 231).

For the spacer 410, an insulating member made of an material such as glass can be used. Furthermore, particles of a conductive material can be dispersed in a base material of the insulating material. Moreover, the surface of the insulating material can be covered with a resistive film.

By providing the spacer 410 with a very low conductivity in the above-described manner, the charging on the spacer 410 can be effectively prevented. The spacer 410 can take a cylindrical shape or a plate-like (wall-like) shape. If a plate-like spacer 410 is used, the plate like spacer 410 can be provided on the row wiring 330 to be projected in the same direction as the row wiring 330 is projected.

In the present invention, the electron emitting device 320 is not particularly limited to a specific type.

However, a field emission (cold cathode) type element can be used as the electron emitting device 320. As the field emission type element, various types of electron emitting devices, such as a surface conduction emission (SCE) type, a spindt type, a carbon nanotube (CNT) type, a metal-insulator-metal (MIM) type, a metal-insulator-semiconductor (MIS) type, or a ballistic electron surface-emitting display (BSD), can be used. As the SCE type, electron emitting devices discussed in Japanese Patent Application Laid-Open No. 07-235255 and Japanese Patent Application Laid-Open No. 2001-167693 have been publicly known.

The scanning on M row wirings 330 is executed in the following manner as illustrated in FIG. 3. In a first selection time period T11 in a scanning period T1, the selection potential Vs is supplied to the first row wiring. On the other hand, the non-selection potential Vn is supplied to the other (M−1) row wirings. In a selection time period T12, which is a period immediately after the selection time period T11 in the scanning period T1, the selection potential Vs is supplied to the second row wiring. On the other hand, the non-selection potential Vn is supplied to the other (M−1) row wirings.

In a selection time period T1M−1 in the scanning period T1, the selection potential Vs is supplied to the M−1th row wiring. On the other hand, the non-selection potential Vn is supplied to the other (M−1) row wirings. In a selection time period T1M, which is a period immediately after the selection time period T1M−1 and which is the last selection time period in the scanning period T1, the selection potential Vs is supplied to the M-th row wiring. On the other hand, the non-selection potential Vn is supplied to the other (M−1) row wirings. By executing the above-described operations, the scanning period T1 ends.

A scanning period T2 starts immediately after the scanning period T1. In a first selection time period T21 in the scanning period T2, the selection potential Vs is supplied to the first row wiring. On the other hand, the non-selection potential Vn is supplied to the other (M−1) row wirings. Thereafter, in the similar manner as described above, each row wiring is selected for each of selection time periods T22 through T2M in the scanning period T2.

In the above-described example, the scanning period T1 is equivalent to one scanning time period TSC and each of the periods T11 through T1M is equivalent to a selection time period in one scanning time period. Furthermore, any of the selection time periods T11 through T1M−1 is the first selection time period TSL1 and any of the selection time periods T12 through T1M, which is after the first selection time period TSL1, is the second selection time period TSL2.

In the example described above, a subsequent scan time period comes “immediately after” a previous scan time period and similarly, a subsequent selection time period comes “immediately after” a previous selection time period. However, if another period (“blanking period”) in which no electron emitting device 320 is driven exists between the periods, a subsequent period after a previous period across a blanking period can be substantially considered as a period “immediately after” the previous period.

To achieve an appropriately high display quality, fifteen frames or more are generally displayed per second. If fifteen frames are displayed per second, one scanning time period is 1/15 second (approximately 67 ms). Therefore, it is useful to set one scanning time period to be 1/15 second or shorter. To achieve a higher image quality, one hundred and twenty frames can be displayed per second, for example. In this case, one scanning time period is equivalent to 1/120 sec (approximately 8 ms).

The length of one selection time period is, although it may differ according to the number of the row wirings 330 and the length of one scanning time period, 1/30 sec (approximately 33 ms) or less if one scanning time period is 1/15 sec and the number of the row wirings 330 is two. If one scanning time period is 1/15 sec and the number of the row wirings 330 is two hundred and forty, the length of one selection time period is 1/3600 sec (approximately 278 μs) or less. On the other hand, if one scanning time period is 1/120 sec and if the number of the row wirings 330 is 1,080, the length of one selection time period is 1/129,600 sec (approximately 7.7 μs) or less.

A modulation signal typically has a pulse shape, which has been modulated according to a gradation signal. The modulation signal can be modulated by a modulation method, such as pulse width modulation (PWM), pulse-amplitude modulation (PAM), or PWM-PAM, which is a combination of PWM and PAM.

The gradation signals may be different for each image to be displayed. The display unevenness, which is the problem to be solved by the present invention, may become easily visible when modulation signals corresponding to the same halftone signals are input to each of a plurality of column wiring 340 to emit light from the light emitting layer 211. Therefore, in setting the supply potential Vb or in confirming the effect of the newly set supply potential Vb, it is useful if an image is displayed in a state in which the entire display screen is evenly adjusted to halftone display. The phenomenon of display unevenness is always possibly to occur in displaying an normal image. Accordingly, by applying the present invention, a normal image can be displayed with a high quality.

In the present invention, the configuration of the potential generation circuit 120 is not limited to any specific configuration if the potential generation circuit 120 can output a predetermined supply potential Vb. For example, the potential generation circuit 120 can be constituted by a waveform generation unit 121 and a high voltage generation unit 122.

For the waveform generation unit 121, a waveform generation unit capable of outputting a periodic waveform having a peak value of several volts can be used. For the period of the waveform, if the progressive scan method is used, the potential generation circuit 120 can generate a waveform of the same period as the scanning time period. On the other hand, if the interlace scan method is used, the potential generation circuit 120 can generate a waveform of half as long as the scanning time period. If the scan is executed by the progressive scan method or the interlace scan method, the waveforms of various shapes, such as a staircase waveform, a sawtooth waveform, a sine wave, or a triangular waveform, can be used.

In particular, the sawtooth waveform can be used if the joint portion 240 is provided on one edge in the Y direction. On the other hand, the triangular waveform can be used if the joint portions 240 are provided on both edges in the Y direction.

In one exemplary method, the high voltage generation unit 122 amplifies the peak value as high as +several kilovolts to several tens of kilovolts and outputs the supply potential in this state. In another exemplary method, a high direct current (DC) voltage generated by the high voltage generation unit 122 is superimposed on a signal waveform output from the waveform generation unit 121.

With respect to the shape of the waveform, the level of the supply potential Vb in the scanning time period can correspond to the variation of the distance between the selected wiring and the joint portion 240 in the scanning time period. In other words, the potential of the waveform can be increased as the distance D of the selection time period becomes longer. On the other hand, the potential of the waveform can be decreased as the distance D of the selection time period becomes shorter.

For example, a case will be described in detail below where the joint portion 240 is provided on one edge in the Y direction and the display panel 110 is scanned by the progressive scan method.

If a resistance value (r(Lmax−Lmin)) on both edges of the anode 220 in the Y direction is Rmax [Ω], the difference between the minimum value and the maximum value of the supply potential Vb can be set higher than 0 V and lower than (2RmaxIe) [V]. To more effectively implement the example, the difference between the minimum value and the maximum value of the supply potential Vb can be set at (RmaxIe) [V]. In this case, the potential generation circuit 120 can output a sawtooth waveform having the above-described difference between the minimum value and the maximum value. In executing the scan by the interlace scan method, the period of the sawtooth waveform can be shortened to half.

If the joint portions 240 are provided on both edges in the Y direction, (r(Lmax−Lmin)) becomes the half of Rmax and the path of the anode potential may be branched into two. Accordingly, the difference between the minimum value and the maximum value of the supply potential Vb can be set higher than 0 V and lower than (RmaxIe/2) [V].

To more effectively implement the example, the difference between the minimum value and the maximum value of the supply potential Vb can be set at (RmaxIe/4) [V]. The potential generation circuit 120 can output a triangular waveform which has the difference between the minimum value and the maximum value of the supply potential Vb described above.

In a typical display panel 110, the above-described Rmax is equal to or between 1 MΩ and 1 GΩ and the emission current Ie is equal to or between 1 μA and 20 μA. Therefore, the difference between the minimum value and the maximum value of the supply potential Vb can be appropriately set within the range of 1 V to 20 kV according to Rmax and Ie.

The display apparatus 100 can also be configured to cause the potential generation circuit 120 to adjust the supply potential Vb according to the image to be displayed, i.e., according to the luminance of the light emission portion. As described above, ΔVa may vary according to Ie. Therefore, the display unevenness can be more effectively suppressed or reduced by adjusting the supply potential Vb according to the variation of Ie (the variation of the luminance of the image to be displayed).

The above-described configuration is effective if the modulation circuit 140 uses PAM or PAM-PWM. More specifically, in this case, the potential generation circuit 120 can be configured to be capable of changing the type of the waveform output from the potential generation circuit 120 for each scanning time period. As a result, at least one of the first potential Vb1 and the second potential Vb2 can be changed for each scanning time period.

For example, by inputting an image signal to the waveform generation unit 121 of the potential generation circuit 120, the waveform generation unit 121 can adjust the peak value of the waveform to be output according to the input image signal. Alternatively, by inputting an image signal to the high voltage generation unit 122 of the potential generation circuit 120, the high voltage generation unit 122 can adjust an amplification factor to amplify the supply potential according to the input image signal.

In the example illustrated in FIG. 3, the synchronization signal (synchronous idle (SYN)) is a trigger signal for outputting a pulse that regulates the start of a scanning time period. In timing of inputting the trigger signal pulse, the scanning circuit 130 starts scanning on the plurality of row wirings 330 in predetermined order according to the synchronization signal as the trigger.

On the other hand, in the timing of inputting the trigger signal pulse (i.e., according to the synchronization signal as the trigger), the modulation circuit 140 sequentially outputs the modulation potentials Vm to be supplied to the electron emitting device 320 that is connected to the selected wiring. In timing of inputting the trigger signal pulse, the potential generation circuit 120 supplies the predetermined supply potential Vb according to the synchronization signal as the trigger.

In each example described above, the synchronization signal is used as the trigger and each of the potential generation circuit 120, the scanning circuit 130, and the modulation circuit 140 executes the above-described operation in the scanning time period according to the synchronization signal as the trigger thereto. However, the control circuit 150 is not limited to the above-described example. More specifically, the control circuit 150 can be implemented by various modifications of the present invention.

More specifically, using a clock signal which includes a plurality of pulses as the synchronization signal, each circuit counts the pulse number. Furthermore, the operation in the scanning time period can be executed based on the pulse number.

In the example described above focusing on the potential generation circuit 120, in which the potential generation circuit 120 adjusts the supply potential Vb according to the image to be displayed, an image signal can be input to the potential generation circuit 120. However, the present invention is not limited to this. In other words, to more effectively implement the present invention, the control circuit 150 can execute the above-described function of the potential generation circuit 120.

In this case, as illustrated in FIG. 1, the control circuit 150 can output an adjustment signal according to an input image signal. By inputting the adjustment signal to the potential generation circuit 120 (the waveform generation unit 121 or the high voltage generation unit 122), the potential generation circuit 120 can adjust the amplification factor for the waveform to be output according to the input adjustment signal, similar to the case where an image signal is input to the potential generation circuit 120.

For example, the voltage drop amount ΔVa, which is the amount of voltage drop that may occur in the irradiation target region 221 of the anode 220 according to the image signal input to the control circuit 150, can be calculated for each selection time period. Furthermore, an average of the amount of voltage drop that may occur in one scanning time period can be calculated. A resulting calculated voltage drop amount is input to the waveform generation unit 121 as the adjustment signal. In this case, the waveform generation unit 121 can be configured to output a waveform according to the adjustment signal.

A first exemplary embodiment of the present invention will now be described below. In the present example, a black matrix, which is constituted by carbon black, was formed on the surface of the first substrate 201, which is composed of a high strain point glass, as the light-shielding layer 212.

In an opening of the black matrix, phosphor layers, which are constituted by R, G, and B phosphors, were formed as the light emitting layer 211. Furthermore, the phosphor layers were arranged in matrix. Each of the phosphor layers arranged in matrix constituted one sub pixel.

Then, the conductive films (metal back) 223, which are made of aluminum, were formed on each of the light emitting layers 211 as films by a filming method. The conductive films 223 were formed across two sub pixels adjacent to each other in the Y direction.

Then, the resistance films 224, which are made of ruthenium oxide, were formed on the light-shielding layer 212 to connect the mutually adjacent conductive films 223 for every two sub pixels. The resistance value of the resistive film 224 was 200 kΩ. In this manner, an anode 220 of a rectangular shape was formed. The resistance value of the anode 220 achieved at both ends thereof in the Y direction was about 100 MΩ.

Furthermore, the feeding electrode 231 was provided to contact the anode 220 along an edge of the anode 220 in the irradiation non-target region 222. The feeding electrode 231 was constituted by a resistance film, which is the resistance portion 233 made of the ruthenium oxide and having the same film thickness as the thickness of the resistance film 224, and the conductive portion 234, which is a metal film made of silver (Ag). As a result, the resistance value between the conductive portion 234 and the anode 220 was 24 MΩ.

In addition, a guard electrode 250, which is constituted by carbon black and which surrounds the feeding electrode 231 and the anode 220, was formed. In the above-described manner, a faceplate 200 having the feeding electrode 231 was prepared.

Furthermore, an electron source 310 was formed on the surface of the second substrate 301 made of high strain point glass, by forming a matrix wiring 350, which includes 1,080 row wirings 330 and 5,760 column wirings 340, and an electron emitting device 320 by a publicly known conventional method. AnSCE type element was used as the electron emitting device 320. In the above-described manner, the rear plate 300 was prepared.

A through-hole was formed on a corner of the second substrate 301. A frame-like shaped sealing member 400 was formed on the rear plate 300 to surround the electron source 310. Furthermore, a plurality of plate-like spacers 410 was provided on the plurality of row wirings 330. For the plate-like spacer 410, a material made of high strain point glass and coated with a semiconductor film made of tungsten-germanium nitride was used.

Furthermore, the faceplate 200 was provided on the rear plate 300 in an opposed manner thereto. Moreover, the feeding terminal 232 was inserted into the through-hole formed on the second substrate 301 and was caused to abut on the feeding electrode 231. Then the through-hole was filled with an adhesive to seal the through-hole.

The sealing member 400 was heated within the hermetic chamber to closely seal the rear plate 300 and the faceplate 200. The joint portion 240 between the feeding electrode 231 and the anode 220 was arranged in parallel to the row wirings 330 and the plurality of spacers 410. The display panel 110 was produced in the above-described manner.

Furthermore, as illustrated in FIG. 1, the scanning circuit 130 was connected to the plurality of row wirings 330 and the modulation circuit 140 was connected to the plurality of column wirings 340. The potential generation circuit 120 was connected to the feeding terminal 232. In addition, the control circuit 150 was connected with the potential generation circuit 120, the scanning circuit 130, and the modulation circuit 140. The potential generation circuit 120 was constituted by the waveform generation unit 121 and the high voltage generation unit 122.

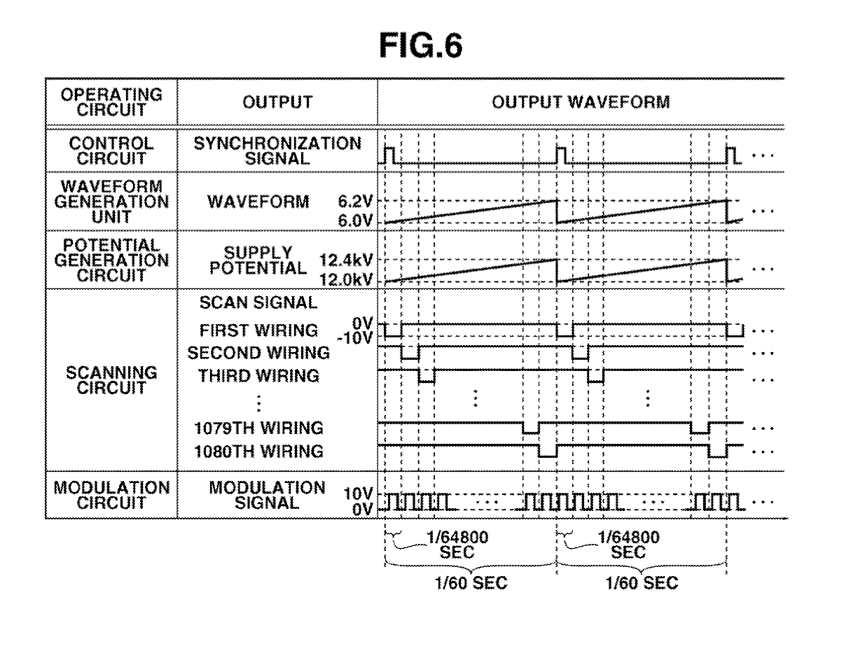

As illustrated in FIG. 6, the waveform output from the waveform generation unit 121 was set to become a sawtooth waveform having a peak value of 6.0 to 6.2 V and a frequency of 60 Hz. Furthermore, the high voltage generation unit 122 was set to amplify the peak value (the amplitude of potential) of the waveform generated by the waveform generation unit 121 by two thousand times and to output the amplified peak value.

Therefore, the potential generation circuit 120 was set to output a supply potential Vb of a sawtooth waveform, a peak value of 12 kV to 12.4 kV, and of a frequency of 60 Hz. In addition, the control circuit 150 was set to control the scanning circuit 130 to output a scan signal for executing the progressive scan at the selection potential of −10 V, the non-selection potential of 0 V, the scanning time period of 11/60 sec, the selection time period of 1/64,800 sec, and the frame frequency of 60 Hz.

In addition, the control circuit 150 was set to control the modulation circuit 140 to output a pulse-modulated signal modulated by PWM of a modulation potential having a peak value of +10 V and a frequency of 64.8 kHz.

To confirm the effect of the example, the pulse width and the peak value of the modulation signal were set to be uniform for all the row wirings 330 in one selection time period and to be constant within one scanning time period. In this manner, an even display was achieved.

In this example, the emission current Ie from one electron emitting device 320 was approximately 4 μA. As a result, by comparing the luminance on the upper edge of the display surface (in the −Y direction) and the luminance on the lower edge of the display surface (in the +Y direction), the difference of the luminance values was 1% or smaller.

On the other hand, when an output of the waveform generation unit 121 was set to be a DC signal and an output of the potential generation circuit 120 was set to be constant, the difference of luminance of about 10% was observed as a result of comparison between the luminance on the upper edge of the display surface and the luminance on the lower edge of the display surface.

According to the present example, the distribution of the luminance values (display unevenness) can be greatly reduced without a particularly complicated configuration or without reducing the effect of restricting a discharge current if any discharge has occurred, by controlling the waveform of an output of the waveform generation unit 121, i.e., the supply potential Vb of the potential generation circuit 120, in the above-described manner.

A second exemplary embodiment will be described in detail below. Basically, the present example has a configuration similar to that of the first example. The present example is different from the first example in the following points. More specifically, the faceplate illustrated in FIG. 6B was used in the present example. In addition, the waveform of a signal generated by the waveform generation unit 121 is different from the waveform of the signal generated by the waveform generation unit 121 in the first example.

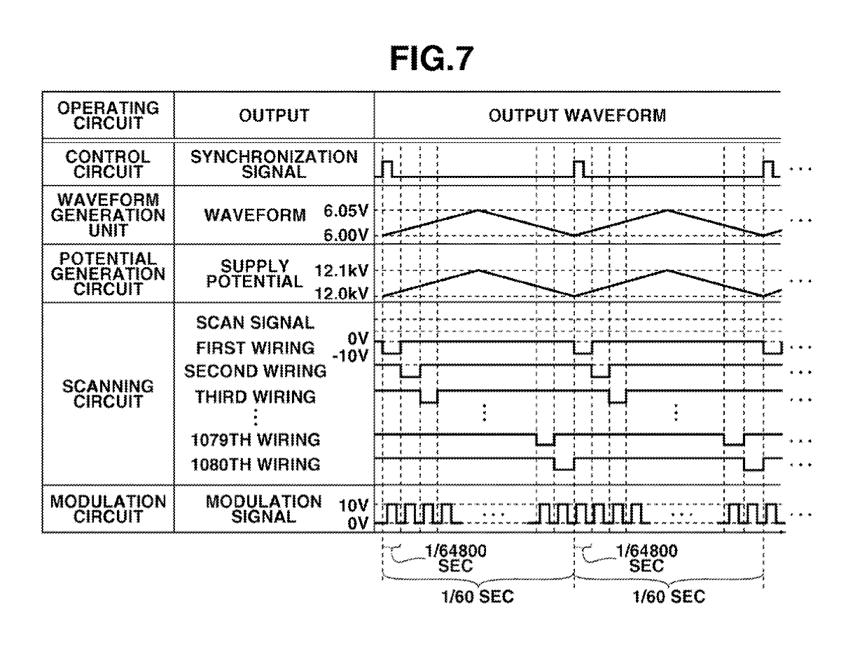

As illustrated in FIG. 7, the waveform of an output of the waveform generation unit 121 was set to be a triangular wave of a peak value of 6.0 V to 6.05 V and a frequency of 60 Hz.In addition, the high voltage generation unit 122 was set to amplify the peak value (the amplitude of potential) of the waveform generated by the waveform generation unit 121 by two thousand times and to output the amplified peak value.

Accordingly, the potential generation circuit 120 was set to output a supply potential Vb of a triangular wave having a peak value of 12.0 kV to 12.1 kV and a frequency of 60 Hz. As a result, by comparing the luminance on the upper edge of the display surface (in the −Y direction) and the luminance on the lower edge of the display surface (in the +Y direction) with the luminance in a center (middle) portion (an intermediate portion between the upper edge and the lower edge) of the display surface, the difference of luminance of 1% or less was observed.

On the other hand, when an output of the waveform generation unit 121 was set to be a DC signal and an output of the potential generation circuit 120 was set to be constant, the difference of potential of about 100 V was observed between the anode potential Va in the center (middle) portion of the display surface and the anode potential Va on the upper edge and the lower edge of the display surface. Furthermore, as a result of comparison between the luminance on the upper edge of the display surface and the luminance on the lower edge of the display surface, the difference of luminance of about 1.5% was observed.

A third exemplary embodiment of the present invention will be described in detail below. Basically, the present embodiment has a configuration similar to that of the first embodiment except that in the present example, the waveform of an output of the waveform generation unit 121 can be changed for each scanning time period and that the modulation circuit 140 uses the PAM.

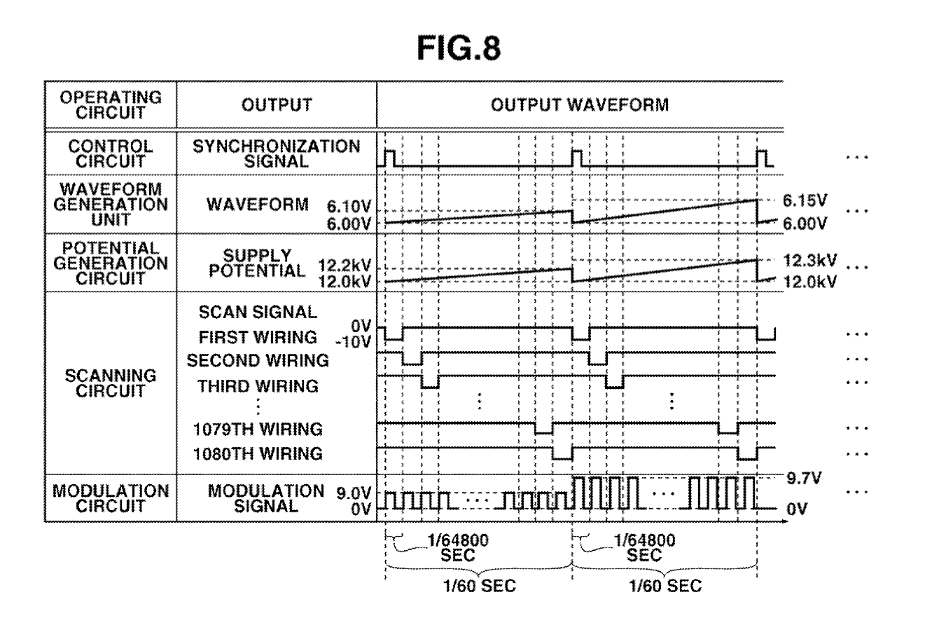

As illustrated in FIG. 8, the control circuit 150 was set to control the scanning circuit 130 to output a scan signal of the selection potential of −10V, the non-selection potential of 0 V, the scanning time period of 16.7 ms, and the selection time period of 15.5 μs. In addition, the control circuit 150 was set to control the modulation circuit 140 to output a modulated signal modulated by PAM of a modulation potential having a peak value of +5 V to +10 V and a frequency of 64.8 kHz.

To confirm the effect of the present embodiment, the peak value and the pulse width of the modulation signal were set to be uniform for all the row wirings 330 in one selection time period and to be constant within one scanning time period. In this manner, an even display was achieved.

Furthermore, the image signal was changed every five seconds. Accordingly, the image was displayed by controlling the peak value of the modulated potential to become +9.0 V in a specific five-second period and by controlling the peak value of the modulated potential to become +9.7 V in another five-second period immediately after the above-described five-second period.

FIG. 8 illustrates examples of scanning time periods (frames) around timing of display change. When the peak value of the modulated potential was at +9.0 V, the emission current Ie from one electron emitting device 320 was approximately 2 μA. On the other hand, when the peak value of the modulated potential was at +9.7 V, the emission current Ie from one electron emitting device 320 was approximately 3 μA.

Therefore, when the peak value of the modulated potential was at +9.7 V, the luminance becomes higher than that in timing when the peak value of the modulated potential was at +9.0 V.

The potential generation circuit 120 was constituted by the waveform generation unit 121 and the high voltage generation unit 122. The waveform of an output of the waveform generation unit 121 was set to be a sawtooth waveform having a peak value ranging from 6.00 v to 6.10 V and a frequency of 60 Hz in a scanning time period immediately before changing the image signal. On the other hand, the waveform of an output of the waveform generation unit 121 was set to be a sawtooth waveform having a peak value ranging from 6.00 v to 6.15 V and a frequency of 60 Hz in a scanning time period immediately after changing the image signal.

Furthermore, the high voltage generation unit 122 was set to amplify the peak value (the amplitude of potential) of the waveform generated by the waveform generation unit 121 by two thousand times and to output the amplified peak value.

Therefore, the potential generation circuit 120 was set to output a supply potential Vb of a sawtooth waveform having a peak value ranging from 12.0 kV to 12.2 kV and a frequency of 60 Hz in the scanning time period immediately before changing the image signal. On the other hand, the potential generation circuit 120 was set to output a supply potential Vb of a sawtooth waveform having a peak value ranging from 12.0 kV to 12.3 kV and a frequency of 60 Hz in the scanning time period immediately after changing the image signal.

With the above-described configuration, a high-quality image whose display unevenness had been effectively reduced, was achieved even if the image signal was changed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-108787 filed May 10, 2010, which is hereby incorporated by reference herein in its entirety.

What is claimed is:

1. A display apparatus comprising:
a display panel including:
a matrix wiring including a plurality of row wirings and a plurality of column wirings;
an electron source including a plurality of electron emitting devices connected to the matrix wiring;
a display member opposed to the electron source;
an anode provided on the display member in an overlapping manner; and
a feeding member connected to the anode in a joint portion;
a scanning circuit connected to the plurality of row wirings;
a modulation circuit configured to output a modulated potential to the plurality of column wirings; and
a potential generation circuit configured to output a first potential, which is higher than a potential of the electron source, to the feeding member during the first selected time period and a second potential, which is higher than the first potential, to the feeding member during the second selected time period,
wherein the plurality of row wirings includes:
a first row wiring; and
a second row wiring located farther from the joint portion than the first row wiring,
wherein the scanning circuit is configured to output, in a first selected time period within one scanning time period, a selection potential to the first row wiring, and a non-selection potential to the second row wiring, and in a second selected time period within the one scanning time period, the non-selection potential to the first row wiring and the selection potential to the second row wiring.

2. The display apparatus according to claim 1, wherein the joint portion provides projecting in a same direction as projection of the plurality of row wirings.

3. The display apparatus according to claim 1,
further comprising a control circuit configured to receive an image signal, and
to output a gradation signal and a synchronization signal according to the image signal,
wherein the modulation circuit outputs the modulated potential according to the gradation signal,
wherein the scanning circuit outputs the selection potential and the non-selection potential according to the synchronization signal, and
wherein the potential generation circuit outputs the first potential and the second potential according to the synchronization signal.

4. The display apparatus according to claim 1, wherein the potential generation circuit changes at least one of the first and second potentials according to the image signal.

5. A display apparatus comprising:
a display panel including:
a matrix wiring including a plurality of row wirings and a plurality of column wirings;
an electron source including a plurality of electron emitting devices and connected to the matrix wiring;
a display member opposed to the electron source;
an anode having a region that overlaps with the display member; and
a feeding member provided externally to the region of the anode and connected to the anode in a joint portion;
a potential generation circuit connected to the feeding member,
a scanning circuit connected to the plurality of row wirings;
a modulation circuit connected to the plurality of column wirings; and
a second potential generation circuit connected to the feeding member and configured to output a supply potential higher than a potential of the electron source to the feeding member,
wherein the joint portion is projected in a same direction as projection of the plurality of row wirings and is provided at least one edge of the anode in a direction of arrangement of the plurality of row wirings,
wherein the scanning circuit line-sequentially scans the plurality of row wirings within one scanning time period,
wherein light emission portions are line-sequentially formed on the display member according to the scan executed during one scanning time period,
wherein the potential generation circuit executes at least one of an operation for raising the supply potential within the one scanning time period as a distance between the joint portion and the light emission portion increases within the one scanning time period, and an operation for lowering the supply potential within the one scanning time period as the distance between the joint portion and the light emission portion decreases within the one scanning time period.

6. The display apparatus according to claim 1,
wherein the joint is provided on one edge of the anode in a direction of arrangement of plurality of row wirings,
wherein the scanning circuit is configured to execute a progressive scan or an interlace scan, and
wherein the potential generation circuit is configured to output a sawtooth waveform.

7. The display apparatus according to claim 1,
wherein joint portions are provided on both edges of the anode in a same direction as arrangement of plurality of row wirings, and
wherein the scanning circuit is configured to execute the progressive scan or the interlace scan, and
wherein the potential generation circuit is configured to output a triangular waveform.

8. The display apparatus according to claim 5, wherein the potential generation circuit is configured to change the supply potential according to a luminance of the light emission portion.

9. The display apparatus according to claim 1, wherein the anode includes:
a plurality of conductive films; and
a resistance film configured to connect the plurality of conductive films together.

10. A method for driving a display panel, wherein the display panel comprises:
a matrix wiring including a plurality of row wirings and a plurality of column wirings;
an electron source including a plurality of electron emitting devices and connected to the matrix wiring;
a display member opposed to the electron source;
an anode provided on the display member in an overlapping manner; and
a feeding member connected to the anode in a joint portion,
wherein the plurality of row wirings includes:
a first row wiring; and
a second row wiring located farther from the joint portion than the first row wiring,
wherein the method comprises:
supplying by a potential generation circuit:
in a first selected time period within one scanning time period, a selection potential to the first row wiring;
in the first selected time period within the one scanning time period, a non-selection potential to the second row wiring;
in a second selected time period within the one scanning time period, the non-selection potential to the first row wiring;
in the second selected time period within the one scanning time period, the selection potential to the second row wiring;
a first potential, which is higher than a potential of the electron source, to the feeding member during the first selected time period; and
a second potential, which is higher than the first potential, to the feeding member during the second selection period.

11. The method according to claim 10, wherein the display panel further comprises:
a scanning circuit connected to the plurality of row wirings; and
a modulation circuit configured to output a modulated potential to the plurality of column wirings.

12. The method according to claim 11, wherein the joint portion provides projecting in a same direction as projection of the plurality of row wirings.

13. The method according to claim 11, wherein the display panel further comprises a control circuit configured to receive an image signal, and to output a gradation signal and a synchronization signal according to the image signal,
wherein the modulation circuit outputs the modulated potential according to the gradation signal,
wherein the scanning circuit outputs the selection potential and the non-selection potential according to the synchronization signal, and
wherein the potential generation circuit outputs the first potential and the second potential according to the synchronization signal.

14. The method according to claim 11, wherein the potential generation circuit changes at least one of the first and second potentials according to the image signal.

15. The method according to claim 11,
wherein the joint is provided on one edge of the anode in a direction of arrangement of plurality of row wirings,
wherein the scanning circuit is configured to execute a progressive scan or an interlace scan, and
wherein the potential generation circuit is configured to output a sawtooth waveform.

16. The method according to claim 11,
wherein joint portions are provided on both edges of the anode in a same direction as arrangement of plurality of row wirings, and
wherein the scanning circuit is configured to execute the progressive scan or the interlace scan, and
wherein the potential generation circuit is configured to output a triangular waveform.

17. The method according to claim 11, wherein the anode includes:
a plurality of conductive films; and
a resistance film configured to connect the plurality of conductive films together.

18. The display apparatus according to claim 5, wherein the anode includes:
a plurality of conductive films; and
a resistance film configured to connect the plurality of conductive films together.

19. The display apparatus according to claim 5,
wherein the joint is provided on one edge of the anode in a direction of arrangement of plurality of row wirings,
wherein the scanning circuit is configured to execute a progressive scan or an interlace scan, and
wherein the potential generation circuit is configured to output a sawtooth waveform.

20. The display apparatus according to claim 5,
wherein joint portions are provided on both edges of the anode in a same direction as arrangement of plurality of row wirings, and
wherein the scanning circuit is configured to execute the progressive scan or the interlace scan, and
wherein the potential generation circuit is configured to output a triangular waveform.
